(19) United States
(12) Patent Application Publication
(10) Pub. No.: US 2010/0085456 A1
(43) Pub. Date: Apr. 8, 2010

(54) SOLID-STATE IMAGE-PICKUP SENSOR AND DEVICE

(75) Inventors: Hiroshi Ito, Tokyo (JP); Hideharu Miyahara, Kamiina-gun (JP); Seisuke Matsuda, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 12/581,531

(22) Filed: Oct. 19, 2009

Related U.S. Application Data
(62) Division of application No. 11/121,382, filed on May 4, 2005, now abandoned.

(30) Foreign Application Priority Data
May 18, 2004 (JP) 2004-148264

(51) Int. Cl. H04N 5/335

(52) U.S. Cl. 348/302; 348/E05.091

(57) ABSTRACT

A solid-state image-pickup sensor comprises a plurality of vertical scan circuits, a plurality of horizontal scan circuits, a pixel section including pixels arranged in a two-dimensional array and performing photoelectric conversion, each of the pixels being connected to one of the plurality of vertical scan circuits and connected to the plurality of horizontal scan circuits, and a selection unit for controlling each of the horizontal scan circuits to independently select and output photoelectrically converted signals read from plural ones of the pixels arrayed in the horizontal direction.

### CROSS REFERENCE TO RELATED APPLICATIONS

This application is a divisional of U.S. patent application Ser. No. 11/121,382, filed May 4, 2005, which claims priority to Japanese Application No. 2004-148264 filed in Japan on May 18, 2004, which are incorporated by reference as if fully set forth.

### FIELD OF INVENTION

1. Field of the Invention

The present invention relates to a solid-state image-pickup sensor including a plurality of vertical scan circuits and a plurality of horizontal scan circuits, and a solid-state image-pickup device using the sensor.

### BACKGROUND

2. Description of the Related Art

The following disclosed example is known as a solid-state image-pickup sensor or a solid-state image-pickup device including a plurality of vertical scan circuits and a plurality of horizontal scan circuits. It enables many pixels to be read within a predetermined time by employing the plurality of vertical scan circuits and the plurality of horizontal scan circuits. Accordingly, when the solid-state image-pickup sensor or device has a fixed number of pixels, the pixels can be read in a shorter time and a frame rate (number of images captured per unit time) can be increased.

In one known example of methods for reading many pixels within a predetermined time to be adapted for, e.g., a motion video image-pickup device, a solid-state image-pickup sensor having a plurality of signal outputs is employed and a plurality of scan circuits are arranged to scan pixels to be read, thereby reading the pixels at the same time.

That known method enables many pixels to be read in a shorter time, but has a problem as follows. When a pixel section is divided into a plurality of scan areas and pixels in the respective scan areas are read by corresponding read units, differences in circuit characteristics of the read units result in variations in characteristics of photoelectrically converted signals and cause fixed pattern noise depending on the scan areas, thereby deteriorating image quality.

To overcome such a problem, for example, Japanese Unexamined Patent Application Publication No. 2000-209503 proposes a technique of forming pixel sections at each boundary between the divided scan areas in overlapped relation, and averaging the photoelectrically converted signals read by the respective read units from the pixels in the overlapped sections. This technique suppresses the deterioration of image quality caused at the boundary between the divided scan areas.

In another known example of the methods for reading many pixels within a predetermined time to be adapted for, e.g., a motion video image-pickup sensor, a pixel section is divided into a plurality of areas and horizontal scan circuits provided in one-to-one relation to the divided pixel areas are scanned at the same time so that pixel signals can be read at a multiplied frame rate.

According to that method, the horizontal scan circuits are able to scan the divided pixel areas at the same time, and therefore a high frame rate can be obtained while reading an entire photo receiving section at the same time. However, because the photo receiving section is divided in the horizontal direction, pixel signals must be rearranged in proper time series after reading of the pixel signals, and complicated processing is required.

To overcome such a problem, Japanese Unexamined Patent Application Publication No. 8-111821, for example, proposes a technique of reading respective signals from a number 2n (n: integer≧1) of every adjacent pixels at the same time in parallel under control by the same vertical and horizontal scan circuits through a number 2n of signal outputs. This technique eliminates the need of extensively rearranging signals read from the divided pixel areas by, e.g., a signal processing circuit in a later stage. In addition, since video signals from respective ones in pairs of the number 2n of signal outputs provide an image read from the entire photo receiving section while alternately thinning the pixels, those video signals from the respective signal outputs can be handled as an image of the entire photo receiving section with low resolution.

### SUMMARY

A solid-state image-pickup sensor according to the present invention comprises a plurality of vertical scan circuits; a plurality of horizontal scan circuits; a pixel section including pixels arranged in a two-dimensional array and performing photoelectric conversion, each of the pixels being connected to one of the plurality of vertical scan circuits and connected to the plurality of horizontal scan circuits; and a selection unit for controlling each of the horizontal scan circuits to independently select and output photoelectrically converted signals read from the plurality of pixels arrayed in the horizontal direction.

In the present invention, plural ones of pixels arranged in the two-dimensional array are selected in at least one of the vertical direction and the horizontal direction to form a pixel group, the selected pixels within the pixel group are connected to the vertical scan circuits differing from each other, and the photoelectrically converted signal from each of the pixels within the pixel group is outputted from different one of the plurality of horizontal scan circuits.

Preferably, the plurality of vertical scan circuits include units for independently controlling an accumulation time in each of the pixels within the pixel group connected to the plurality of vertical scan circuits.

As an alternative, preferably, the plurality of vertical scan circuits include units for independently controlling accumulation start timing and accumulation end timing in each of the pixels within the pixel group connected to the plurality of vertical scan circuits.

A solid-state image-pickup device according to the present invention comprises a solid-state image-pickup sensor comprising a plurality of vertical scan circuits; a plurality of horizontal scan circuits; a pixel section including pixels arranged in a two-dimensional array and performing photoelectric conversion, each of the pixels being connected to one of the plurality of vertical scan circuits and connected to the plurality of horizontal scan circuits; and a selection unit for controlling each of the horizontal scan circuits to independently select and output photoelectrically converted signals read from the plurality of pixels arrayed in the horizontal direction, and a read control unit for controlling the plurality of vertical scan circuits, the plurality of horizontal scan circuits, and the selection unit.

In the solid-state image-pickup sensor of the present invention, since a plurality of vertical scan circuits and a plurality of horizontal scan circuits are provided and these vertical and horizontal scan circuits are assigned so as to perform scan per pixel, the pixels can be read with each of respective scan sequences executed by the plurality of scan circuits under independent scan conditions set per scan circuit without being affected by any scan sequences of the other scan circuits. Also, since the photoelectrically converted signal from each pixel is connected to the plurality of horizontal scan circuits and can be outputted from any desired one(s) of the horizontal scan circuits by using a pixel selection unit, respective outputs from the plurality of horizontal scan circuits can be each freely set to be obtained from any desired scan area.

Further, scan conditions, such as an accumulation time, accumulation start and end timings, and a frame rate, can be independently changed for each frame image made up of respective pixel signals read by the plurality of different horizontal scan circuits.

As a result, it is possible to add various applications (functions) to an image-pickup device equipped with the above-described solid-state image-pickup sensor.

### BRIEF DESCRIPTION OF THE DRAWING(S)

FIG. 1 is a block diagram of a solid-state image-pickup sensor according to a first embodiment of the present invention;

FIG. 2 is a chart showing a read sequence of photoelectrically converted signals in the solid-state image-pickup sensor of FIG. 1;

FIG. 3 is a block diagram of a solid-state image-pickup sensor according to a second embodiment of the present invention;

FIG. 4 is a chart showing a read sequence of photoelectrically converted signals in the solid-state image-pickup sensor of FIG. 3;

FIG. 5 is a configuration figure of pixels and a control unit for the pixels in a solid-state image-pickup sensor according to a third embodiment of the present invention;

FIG. 6 is a chart showing a read sequence of photoelectrically converted signals in the solid-state image-pickup sensor according to the third embodiment;

FIG. 7 is a configuration figure of pixels and a control unit for the pixels in a solid-state image-pickup sensor according to a fourth embodiment of the present invention;

FIG. 8 is a chart showing a read sequence of photoelectrically converted signals in the solid-state image-pickup sensor according to the fourth embodiment;

FIG. 9 is a basic block diagram of an image-pickup device according to a fifth embodiment of the present invention;

FIG. 10 is a block diagram of the image-pickup device with an image-pickup condition setting function according to the fifth embodiment of the present invention; and

FIG. 11 is a chart showing a sequence for controlling a solid-state image-pickup sensor by a read control unit in the image-pickup device of FIG. 10.

### DETAILED DESCRIPTION OF THE PREFERRED EMBODIMENTS

Embodiments of the present invention will be described below with reference to the drawings.

### First Embodiment

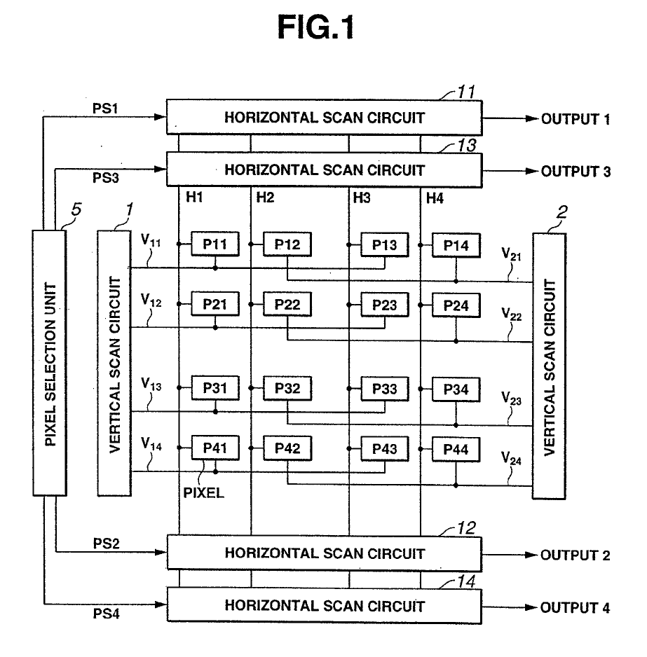

FIG. 1 is a block diagram of a solid-state image-pickup sensor according to a first embodiment of the present invention. This first embodiment is described in connection with, by way of example, a solid-state image-pickup sensor of X-Y addressing type. In the X-Y addressing type, pixels constructed of photoelectric conversion elements are X-Y addressed to detect charges generated in the conversion elements.

The solid-state image-pickup sensor shown in the first embodiment of FIG. 1 comprises a plurality (2 in FIG. 1) of vertical scan circuits 1, 2, a plurality (4 in FIG. 1) of horizontal scan circuits 11, 12, 13 and 14, a pixel section including a plurality (16 in FIG. 1) of pixels constructed of respective photoelectric conversion elements arrayed in a matrix, each of which is connected to one of the plurality of vertical scan circuits 1, 2 and connected to the plurality (4 in FIG. 1) of horizontal scan circuits 11, 12, 13 and 14, and a pixel selection unit 5 for controlling each of the horizontal scan circuits to independently select and output photoelectrically converted signals read from the plurality (4 in FIG. 1) of pixels arrayed in the horizontal direction. The vertical scan circuits 1, 2, the horizontal scan circuits 11-14, and the pixel selection unit 5 are controlled by a read control unit (not shown).

The pixel section is made up of 4×4 pixels P₁₁-P₄₄ arrayed in a matrix. The vertical scan circuits 1, 2 control read of the photoelectrically converted signals generated in the pixels P₁₁-P₄₄. The horizontal scan circuits 11-14 receive and send the photoelectrically converted signals read from the pixels under the control of the vertical scan circuits 1, 2 while shifting those signals to subsequent stages in sequence. Further, the pixel selection unit 5 selects, per pixel, the photoelectrically converted signal that is to be sent while being shifted to the subsequent stage in sequence in each of the horizontal scan circuits 11-14.

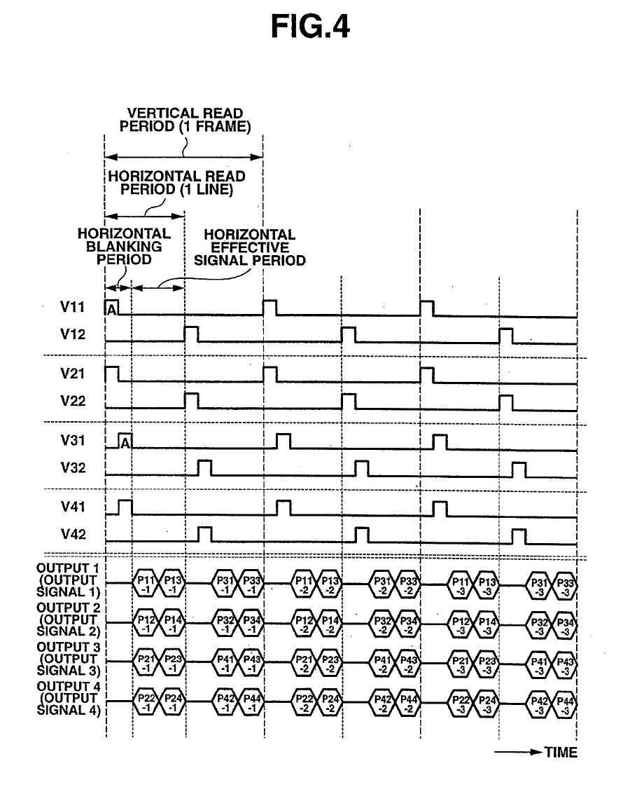

Connected to the pixels are vertical selection lines V₁₁-V₂₄ comprising vertical selection lines V₁₁-V₁₄ extending from the vertical scan circuit 1 and vertical selection lines V₂₁-V₂₄ extending from the vertical scan circuit 2, as well as vertical signal lines H₁-H₄ for reading, to all of the horizontal scan circuits 11-14, the plurality (4 in FIG. 4) of photoelectrically converted signals read from the same horizontal line having the plurality (4 in FIG. 4) of pixels. Stated another way, the vertical selection lines V₁₁-V₁₄ and the vertical selection lines V₂₁-V₂₄ corresponding to horizontally alternate pixels are connected to be controlled respectively by the particular vertical scan circuits 1, 2, while the vertical signal lines H₁-H₄ are each shared by the pixels per column and connected to all of the horizontal scan circuits 11-14.

Further, pixel selection control lines PS1-PS4 are connected from the pixel selection unit 5 to the horizontal scan circuits 11-14 so that the photoelectrically converted signals to be sent while being shifted to the subsequent stage in sequence in each of the horizontal scan circuits 11-14 can be individually selected per pixel.

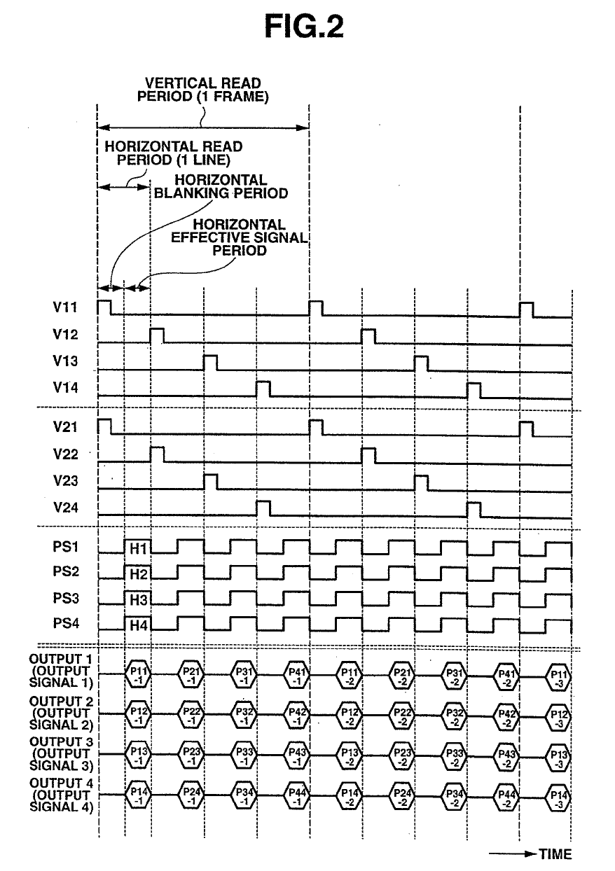

The operation of the solid-state image-pickup sensor of FIG. 1 will be described below with reference to FIG. 2.

FIG. 2 shows a read sequence of the photoelectrically converted signals in the solid-state image-pickup sensor of FIG. 1.

Note that the symbols of the vertical selection lines V₁₁-V₂₄ and the pixel selection control lines PS1-PS4 in FIG. 1 are used in FIG. 2 as denoting respective names of corresponding vertical selection pulses and respective names of corresponding pixel selection control pulses.

Terms used in FIG. 2 are briefly described. The vertical selection pulses V₁₁-V₂₄ from the vertical scan circuits 1, 2 control the timing of reading from the pixels. With the timing control by the vertical selection pulses V₁₁-V₂₄, the photoelectrically converted signals read from the pixels are transferred to the horizontal scan circuits 11-14. In this embodiment, during a horizontal blanking period, the pixels are scanned for transfer of the photoelectrically converted signals to the horizontal scan circuits upon the read start timing decided by the respective vertical selection pulses. Stated another way, the photoelectric conversion elements perform the operation of transferring the respective signals to the horizontal scan circuits in response to a rise of the corresponding vertical selection pulses during the horizontal blanking period. After the transfer to the horizontal scan circuits, the photoelectrically converted signals are actually taken out as outputs 1-4 from the horizontal scan circuits during a horizontal effective signal period. Both the horizontal blanking period and the horizontal effective signal period constitute a horizontal read period (1 line). Further, all (4 in FIG. 2) of the horizontal read periods constitute a vertical read period (1 frame). In FIG. 2, a vertical blanking period is omitted which is required in addition to the horizontal blanking period for proper operation of the solid-state image-pickup sensor.

First, the vertical selection pulses (one set of the paired pulses V₁₁ and V₂₁, V₁₂ and V₂₂, V₁₃ and V₂₃, and V₁₄ and V₂₄) from the vertical scan circuits 1, 2 are brought to an H level during the predetermined horizontal blanking period, thereby turning on respective switches (not shown) that are provided to send (read) the photoelectrically converted signals from the pixels to the vertical signal lines H₁-H₄. The photoelectrically converted signals from the pixels are sent to the predetermined horizontal scan circuits via the vertical signal lines H₁-H₄, and signal charges are temporarily accumulated in, e.g., capacitors (not shown) inside the horizontal scan circuits. Then, the accumulated photoelectrically converted signals are read out as the outputs 1-4 in sequence from the solid-state image-pickup sensor during the horizontal effective signal period.

For example, the pixels P₁₁, P₁₃ in the first row in FIG. 1 are controlled by the vertical selection pulse V₁₁ such that the photoelectrically converted signals accumulated in those pixels are sent to the horizontal scan circuits 11, 13 via the vertical signal lines H₁, H₃ and are read out as photoelectrically converted signals P₁₁₋ₙ, P₁₃₋ₙ (n is an integer≧1 and indicates a frame number) in sequence during the horizontal effective signal period to become the outputs 1, 3, respectively. On the other hand, the pixels P₁₂, P₁₄ are controlled by the vertical selection pulse V₂₁ at the same time as the read timing of the pixels P₁₁, P₁₃ such that the photoelectrically converted signals accumulated in those pixels are sent to the horizontal scan circuits 12, 14 via the vertical signal lines H₂, H₄ and are read out as photoelectrically converted signals P₁₂₋ₙ, P₁₄₋ₙ (n is an integer≧1 and indicates a frame number) in sequence during the horizontal effective signal period to become the outputs 2, 4, respectively.

The other pixels in each of the second through fourth rows are likewise scanned, whereby the respective photoelectrically converted signals are read out as the predetermined outputs 1-4 to provide output signals 1-4 shown in FIG. 2.

When the photoelectrically converted signals are read in sequence from the horizontal scan circuits 11-14, the pixel selection control pulses PS1-PS4 are referred to. If the pixel selection control pulses PS1-PS4 are at an H level, the photoelectrically converted signals from the corresponding pixels are output in sequence, and if they are at an L level, the corresponding photoelectrically converted signals are not read. In FIG. 2, all the pulses PS1-PS4 are at an H level, and therefore all the pixels are read without skipping any pixel.

FIG. 2 shows the state where the pixel selection control pulses PS1-PS4 are set to an H level during the horizontal effective signal periods in all of the horizontal read periods within the vertical read period (1 frame), and hence the photoelectrically converted signals P₁₁₋₁, P₄₄₋₁ are outputted at the outputs 1-4 of all the horizontal scan circuits 11-14 during the vertical read period (1 frame) without any dropout.

In other words, the function of the pixel selection unit 5 in FIG. 1 is particularly effective, for example, when it is intended to pick up desired ones, e.g., every other pixel, of all the pixels or to pick up those pixels in a particular part of an entire area defined by all the pixels (namely, to pick up a particular area in a flexible manner), thereby providing a small frame image constituted by only the necessary pixels with omission of all the other pixels, in the state where the vertical selection pulses V₁₁-V₁₄ controlled by the vertical scan circuit 1 and the vertical selection pulses V₂₁-V₂₄ controlled by the vertical scan circuit 2 are set to an H level in sequence during each horizontal blanking period so as to read all the pixels.

Further, in this first embodiment, since all the pixels P₁₁-P₄₄ are connected to all the horizontal scan circuits 11-14, the photoelectrically converted signals (pixel signals) from the pixels P₁₁-P₄₄ can be read and accumulated in the horizontal scan circuits 11-14 at the same time by the read control in response to the vertical selection pulses V₁₁, V₂₁ from the vertical scan circuits 1, 2. Then, by selecting the pixel signals accumulated in each of the horizontal scan circuits by the pixel selection unit 5 in a desired manner, desired ones of the image pixels can be outputted at the same time from the horizontal scan circuits. For example, a signal from the pixel P₁₂ can be outputted from two or more of the horizontal scan circuits 11-14 at the same time instead of outputting it from only one of the horizontal scan circuits 11-14. In the operation example shown in FIG. 2, the pixel selection unit 5 is operated so as to select one unique pixel from each of the horizontal scan circuits and outputs the selected pixels at the same time.

Thus, although the first embodiment is described as an operation example in which only one pixel is read from each of the horizontal scan circuits during one horizontal read period, it is needless to say that the configuration and control can be modified to be able to read a plurality of pixels during one horizontal read period.

More specifically, with the design configured to output one pixel signal from each of the four horizontal scan circuits as in FIG. 1, when the number of pixels in the horizontal direction is increased beyond four, the number of the horizontal scan circuits must also be increased corresponding to the increased number of pixels. This is disadvantageous from the viewpoint of practical application because not only the horizontal scan circuits, but also the number of the associated signals lines must be increased. To cope with such a problem, all pixels in the horizontal direction are taken in by each of the four horizontal scan circuits, and timing control is performed such that a plurality of pixel signals are selected and outputted at the same time from each horizontal scan circuit during one horizontal read period (instead of selecting and outputting only one pixel signal). As a result, a total number of pixels can be increased beyond 4×4 while keeping the number of the horizontal scan circuits the same, i.e., 4, without changing the number of the associated signal lines.

As described above, with the solid-state image-pickup sensor comprising a plurality of vertical scan circuits, a plurality of horizontal scan circuits, a pixel section including pixels arranged in a two-dimensional array and performing photoelectric conversion, each of the pixels being connected to one of the plurality of vertical scan circuits and the plurality of horizontal scan circuits, and selection means for controlling each of the horizontal scan circuits to independently select and output photoelectrically converted signals read from plural ones of the pixels arrayed in the horizontal direction, the pixels can be read with each of respective scan sequences executed by the plurality of scan circuits under independent scan conditions (such as setting of a scan area and skipping of read pixels) set per scan circuit without being affected by any scan sequences of the other scan circuits.

Also, since a plurality of pixel signals read at the same time constitute each small frame, the frame rate to read all the pixel signals can be increased and there is no need of extensively rearranging signals read from divided pixel areas by, e.g., a signal processing circuit in a later stage. In addition, since video signals from each signal output provide an image read from an entire photo receiving section while thinning the pixels, it is a matter of course that those video signals from each signal output can be handled as an image of the entire photo receiving section (i.e., a small frame image) with low resolution.

### Second Embodiment

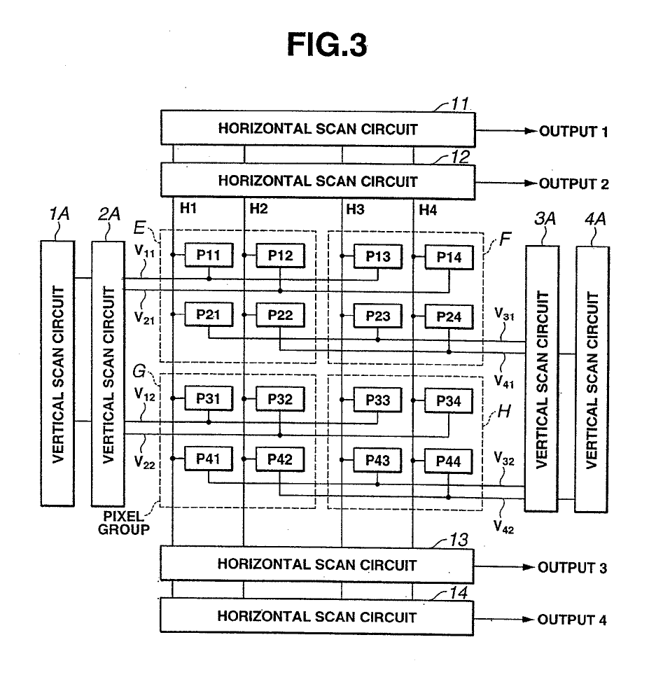

FIG. 3 is a block diagram of a solid-state image-pickup sensor according to a second embodiment of the present invention. As with the first embodiment, this second embodiment is also described in connection with, by way of example, a solid-state image-pickup sensor of X-Y addressing type.

The second embodiment has a basic configuration similar to that of the first embodiment except that two more vertical scan circuits are additionally provided. A pixel selection unit is omitted in FIG. 3 for the sake of simplicity in the following description of basic (specific) operation of the solid-state image-pickup sensor shown in FIG. 3.

Vertical selection lines V₁₁, V₁₂ are extended from one 1A of four vertical scan circuits 1A, 2A, 3A and 4A. The vertical selection line V₁₁ is connected to pixels P₁₁, P₁₃, and the vertical selection line V₁₂ is connected to pixels P₃₁, P₃₃. Vertical selection lines V₂₁, V₂₂ are extended from the vertical scan circuit 2A. The vertical selection line V₂₁ is connected to pixels P₁₂, P₁₄, and the vertical selection line V₂₂ is connected to pixels P₃₂, P₃₄.

Similarly, vertical selection lines V₃₁, V₃₂ are extended from the vertical scan circuit 3A. The vertical selection line V₃₁ is connected to pixels P₂₁, P₂₃, and the vertical selection line V₃₂ is connected to pixels P₄₁, P₄₃. Vertical selection lines V₄₁, V₄₂ are extended from the vertical scan circuit 4A. The vertical selection line V₄₁ is connected to pixels P₂₂, P₂₄, and the vertical selection line V₄₂ is connected to pixels P₄₂, P₄₄.

Each pixel group is formed in units of 2×2 adjacent pixels in the vertical and horizontal directions. Four pixels constituting the pixel group are connected to vertical selection lines so that read of photoelectrically converted signals from the four pixels can be controlled by the respective vertical scan circuits differing from one another, whereby the photoelectrically converted signals are read in accordance with a later-described read sequence shown in FIG. 4.

For example, the pixels P₁₁, P₁₂, P₂₁ and P₂₂ constitute a pixel group E. Of the four pixels P₁₁, P₁₂, P₂₁ and P₂₂ constituting the pixel group E, the read of the photoelectrically converted signal from the pixel P₁₁ is controlled via the vertical selection line V₁₁ extended from the vertical scan circuit 1A, and the read of the photoelectrically converted signal from the pixel P₁₂ is controlled via the vertical selection line V₂₁ extended from the vertical scan circuit 2A. Further, the read of the photoelectrically converted signal from the pixel P₂₁ is controlled via the vertical selection line V₃₁ extended from the vertical scan circuit 3A, and the read of the photoelectrically converted signal from the pixel P₂₂ is controlled via the vertical selection line V₄₁ extended from the vertical scan circuit 4A.

Then, the photoelectrically converted signals from the pixels P₁₁, P₁₂, P₂₁ and P₂₂ within the pixel group E are outputted as outputs 1-4 from a plurality (4 in FIG. 3) of different horizontal scan circuits 11-14 independently of one another.

Similarly, the pixels P₁₃, P₁₄, P₂₃ and P₂₄ constitute a pixel group F, the pixels P₃₁, P₃₂, P₄₁ and P₄₂ constitute a pixel group G, and the pixels P₃₃, P₃₄, P₄₃ and P₄₄ constitute a pixel group H.

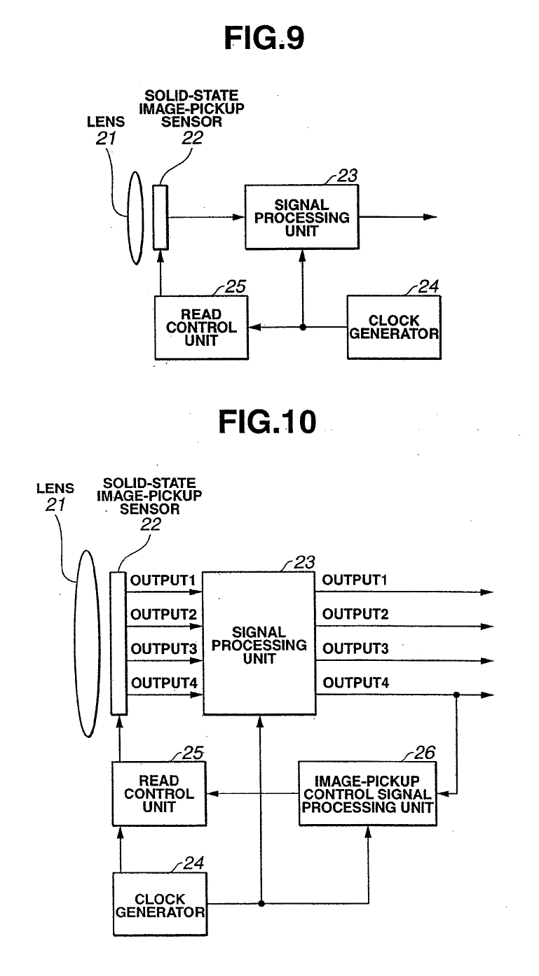

The horizontal scan circuits 11-14 in FIG. 3 are arranged in a different layout from that of the horizontal scan circuits in FIG. 1, but they operate in the same manner as those in FIG. 1. Each of the horizontal scan circuits 11-14 is connected to all of the pixels P₁₁-P₄₄. Also, each horizontal scan circuit reads the photoelectrically converted signals read from the relevant pixels during the horizontal read period, and selects the photoelectrically converted signal(s) from a certain number of pixels, e.g., one pixel, in response to a pixel selection pulse from the pixel selection unit (not shown), thereby outputting, as one of the outputs 1-4, the photoelectrically converted signal(s). Taking the pixels P₁₁, P₁₂, P₂₁ and P₂₂ within the pixel group E as an example, of all the read photoelectrically converted signals, the photoelectrically converted signal from the pixel P₁₁ is selected by the horizontal scan circuit 11, the photoelectrically converted signal from the pixel P₁₂ is selected by the horizontal scan circuit 12, the photoelectrically converted signal from the pixel P₂₁ is selected by the horizontal scan circuit 13, and the photoelectrically converted signal from the pixel P₂₂ is selected by the horizontal scan circuit 14. Then, the selected photoelectrically converted signals are outputted as the outputs 1-4 from the respective horizontal scan circuits. The vertical scan circuits 1A-4A, the horizontal scan circuits 11-14, and the pixel selection unit (not shown) are controlled by a read control unit (see FIGS. 9 and 10).

The operation of the solid-state image-pickup sensor of FIG. 3 will be described below with reference to FIG. 4.

FIG. 4 shows a read sequence of the photoelectrically converted signals in the solid-state image-pickup sensor of FIG. 3.

Note that the symbols of the vertical selection lines V₁₁, V₁₂, V₂₁, V₂₂, V₃₁, V₃₂, V₄₁ and V₄₂ in FIG. 3 are used in FIG. 4 as denoting respective names of corresponding vertical selection pulses.

For example, of the pixels within the pixel group E shown in FIG. 3, the pixel P₁₁ is controlled by the vertical selection pulse V₁₁ from the vertical scan circuit 1A such that the photoelectrically converted signal accumulated in the pixel P₁₁ is sent to the horizontal scan circuit 11 via the vertical signal line H₁ and is read out as a photoelectrically converted signal P₁₁₋ₙ (n is an integer≧1 and indicates a frame number) during the horizontal effective signal period to become the output 1. Similarly, the pixel P₁₂ is controlled by the vertical selection pulse V₂₁ from the vertical scan circuit 2A such that the photoelectrically converted signal accumulated in the pixel P₁₂ is sent to the horizontal scan circuit 12 via the vertical signal line H₂ and is read out as a photoelectrically converted signal P₁₂₋ₙ (n is an integer≧1 and indicates a frame number) during the horizontal effective signal period to become the output 2. The pixel P₂₁ is controlled by the vertical selection pulse V₃₁ from the vertical scan circuit 3A such that the photoelectrically converted signal accumulated in the pixel P₂₁ is sent to the horizontal scan circuit 13 via the vertical signal line H₁ and is read out as a photoelectrically converted signal P₂₁₋ₙ (n is an integer≧1 and indicates a frame number) during the horizontal effective signal period to become the output 3. The pixel P₂₂ is controlled by the vertical selection pulse V₄₁ from the vertical scan circuit 4A such that the photoelectrically converted signal accumulated in the pixel P₂₂ is sent to the horizontal scan circuit 14 via the vertical signal line H₂ and is read out as a photoelectrically converted signal P₂₂₋ₙ (n is an integer≧1 and indicates a frame number) during the horizontal effective signal period to become the output 4.

The pixels in the other pixel groups F, G and H are also similarly scanned and read out as the predetermined outputs 1-4 to provide output signals 1-4 shown in FIG. 4. In the timing chart of FIG. 4, as described above in connection with the first embodiment, an H level of the vertical selection line represents the timing at which the photoelectrically converted signal is read from the predetermined pixel.

When, for example, the pixels P₁₁, P₂₁ are both read during the same horizontal blanking period at the time of sending the photoelectrically converted signals from the pixels to the vertical signal lines H₁-H₄, there may occur a trouble that the photoelectrically converted signals from the different pixels are simultaneously transmitted through the vertical signal line H₁ and those signals collide with each other. Such a trouble can be prevented, by sending the photoelectrically converted signals to the vertical signal line H₁, as indicated by A in FIG. 4, at the respective read timings of the vertical selection pulses V₁₁, V₃₁ shifted from each other during the same horizontal blanking period. In order to send the photoelectrically converted signals to the different horizontal scan circuits at the same timing, a plurality of vertical signal lines may be provided instead of one vertical signal line described above.

The term “small frame image” means, in the first embodiment, an area formed by pixels alterably selected from an entire pixel area by the pixel selection unit. On the other hand, in the second and subsequent embodiments, the entire pixel area is read by each of all (four) horizontal scan circuits, and the term “small frame image” means an image formed by each of the outputs 1-4 from the horizontal scan circuits. Then, a small frame image can be displayed by outputting, for example, only the output 1 among the outputs 1-4 from the four horizontal scan circuits. Stated another way, referring to FIG. 3, the photoelectrically converted signals obtained as the output 1 from the pixels P₁₁, P₁₃, P₃₁ and P₃₃ during the vertical read period (1 frame) provide a thinned picture formed by alternately thinning all the pixel signals. Accordingly, those thinned pixel signals can be directly displayed on a display unit after signal processing. The thus-displayed thinned picture is not an image formed by some part of one line, but it is a ¼-size image formed by thinning all the pixel signals at the same proportion in both directions of length and width.

Further, the configuration of FIG. 1 requires a time corresponding to 4 lines to read the pixels of one frame from the pixel section (1 frame comprising 4×4 pixels) as shown in FIG. 2. With the configuration of FIG. 3, however, the pixels of one frame can be read from the pixel section (1 frame comprising 4×4 pixels) in a time corresponding to 2 lines as shown in FIG. 4, and therefore the read rate, i.e., the frame rate, can be increased. This increase of the frame rate is attributable to the fact that four pixels are outputted as the outputs 1-4 at the same time in both the configurations of FIGS. 1 and 3 as shown in FIGS. 2 and 4, respectively, and only four pixels are read out at the same timing during the horizontal blanking period in FIG. 1, while eight pixels are read out substantially at the same timing during the horizontal blanking period in FIG. 3. Looking at such a difference in terms of horizontal line, the pixels corresponding to one horizontal line are read out at the same time in the case of FIG. 1, while the pixels corresponding to two horizontal lines are read out substantially at the same time in the case of FIG. 3.

Moreover, in the case of FIG. 1, there are four outputs, but only two types of read operations can be prepared because the read timing is controlled by two vertical scan circuits. For example, the pixels P₁₁, P₁₃ are sent to the horizontal scan circuits at the same time with the control of the vertical scan line V₁₁ by the vertical scan circuit 1. In other words, those pixels are sent at the same time and outputted from the different horizontal scan circuits 11, 13. On that occasion, the accumulation time, the accumulation start/end timing, etc. are exactly the same for both the pixels (because they are decided depending on the read control by the vertical scan circuit 1). In the case of FIG. 1, therefore, when trying to modify, e.g., the accumulation time and the shutter timing (i.e., the accumulation timing) to different settings, it is possible to control the output timing (i.e., the shutter start timing and the shutter end timing) and the accumulation time in only two types, namely in units of only any two of the four outputs. In the case of FIG. 3, since the read timing is controlled by the four vertical scan circuits, individual read operations can be made in a completely independent manner on the pixels that are outputted as the four outputs at the same time.

As described above, with the configuration that plural ones of pixels arranged in a two-dimensional array are selected in at least one of the vertical direction and the horizontal direction to form a pixel group, the selected pixels within the pixel group are connected to the vertical scan circuits differing from each other, and the photoelectrically converted signal from each of the pixels within the pixel group is outputted from different one of the plurality of horizontal scan circuits, each pixel can be controlled in a completely independent manner by each of the vertical scan circuits for executing the read control of the pixels and by each of the horizontal scan circuits from which the pixel is outputted. As a result, the scan conditions (such as a scan area and skipping of read pixels) can be set for each of the outputs without being affected by the other output systems.

According to the broadest concept of the present invention, each of the pixels constituting the solid-state image-pickup sensor is connected to all of the horizontal scan circuits such that a signal from the same pixel may be read into all of the horizontal scan circuits, and the pixel signals read into each of the horizontal scan circuits are outputted after thinning under the control of the pixel selection unit. For example, the pixel P₁₁ is read into all of the horizontal scan circuits 11-14 and is selectively outputted as one(s) of the outputs 1-4 from the horizontal scan circuits under the control of the pixel selection unit. In practice, such selective control is executed using the pixel selection control pulses PS1-PS4 from the pixel selection unit (see FIG. 1). As a result, any desired pixel can be selected from any of the horizontal scan circuits. It can be said that the first embodiment shown in FIGS. 1 and 2 and the second embodiment shown in FIGS. 3 and 4 represent the case where control (restriction) is preset by the pixel selection unit so as to output different pixels as the pixel selection outputs 1-4 from the horizontal scan circuits 1-14.

Additionally, according to the concept represented by the pixel group in FIG. 3 (in which each pixel within the pixel group is connected to different one of the vertical scan circuits and the photoelectrically converted signal is a pixel signal outputted from different one of the plurality of horizontal scan circuits), the scan conditions for outputting the plurality of pixels constituting the pixel group can be individually set by the vertical scan circuits connected in one-to-one relation to the pixels. The term “scan conditions” used herein means the accumulation time, the accumulation start/end timing, the frame rate, etc.

Another embodiment changing the accumulation time per pixel will be described as a third embodiment, and still another embodiment changing the accumulation start and end timings per pixel will be described as a fourth embodiment.

### Third Embodiment

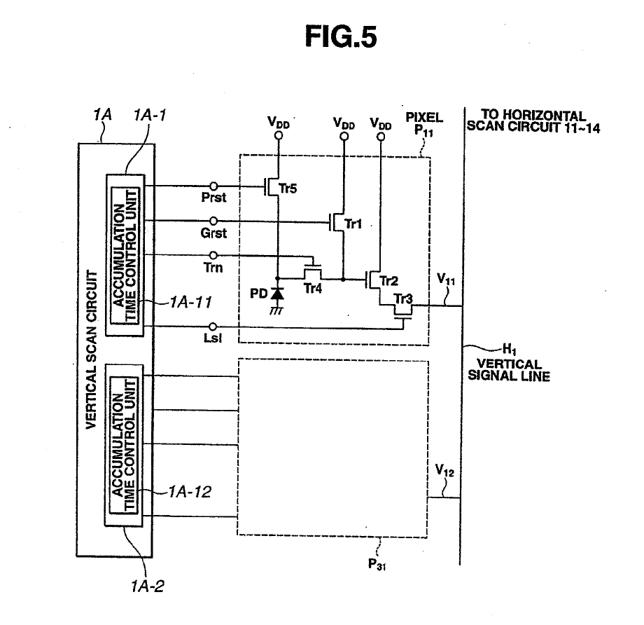

FIG. 5 is a configuration figure of pixels and a control unit for the pixels in a solid-state image-pickup sensor according to a third embodiment of the present invention. The block diagram of the solid-state image-pickup sensor according to the third embodiment of the present invention is the same as that shown in FIG. 3, and therefore it is omitted in FIG. 5.

Because all of the pixels have the same configuration, the following description is made of, by way of example, the pixel P₁₁ for which the read is controlled by the vertical scan circuit 1A shown in FIG. 3. Any of the other pixels also has the same configuration as the pixel P₁₁. The read of the pixel P₁₁ is controlled by the vertical scan circuit 1A together with the pixel P₃₁. Any of the other vertical scan circuits 2A-4A also has the same configuration as the vertical scan circuit 1A.

FIG. 5 shows a typical one of the pixels and the control unit for the pixels in the form of a simplified diagram, including components and signals named as shown. The components of the pixel and the signals supplied to the pixel are denoted by abbreviations.

Referring to FIG. 5, the pixel P₁₁ comprises a field effect transistors Tr1, Tr2, Tr3, Tr4 and Tr5 each serving as a switching element, and a photodiode PD serving as a photo receiving element. The vertical scan circuit 1A includes a control unit 1A-1 for executing read control of the pixel P₁₁ and a control unit 1A-2 for executing read control of the pixel P₃₁.

The configuration of the pixel P₁₁ controlled by the control unit 1A-1 will be described below. Control pulses denoted by symbols Prst, Grst, Trn and Lsl are inputted as read control signals to the pixel P₁₁ from the control unit 1A-1.

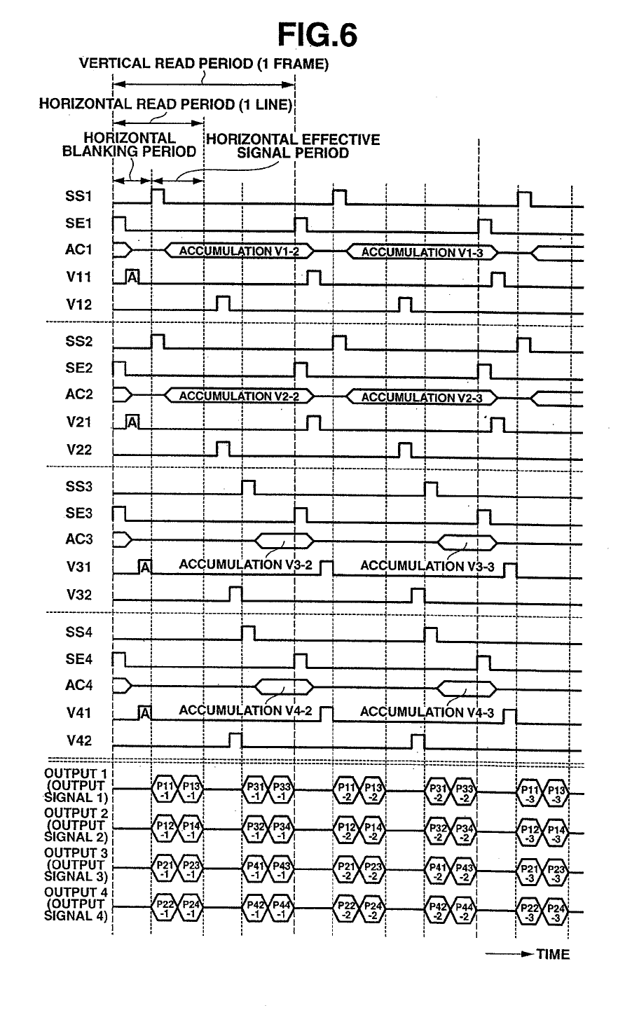

Tr1 denotes a transistor for resetting gate charges of Tr2, and Tr2 denotes a signal read transistor. Tr3 denotes a transistor for selecting the horizontal read line, and Tr4 denotes a transistor for transferring charges accumulated in the photodiode PD. Tr5 denotes a transistor for resetting the charges in the photodiode PD. Prst denotes a PD charge reset pulse (corresponding to a shutter start pulse SS1 in FIG. 6), and Grst denotes a Tr2 gate charge reset pulse. Trn denotes a transfer pulse (corresponding to a shutter end pulse SE1 in FIG. 6) for transferring the PD charges to the gate of Tr2, and Lsl denotes a read line selecting pulse.

One end of a drain-source line of Tr5 is connected to a power source V_{DD}, and the other end thereof is connected to a reference potential point via the cathode and anode of the photodiode PD. The reset pulse Prst can be inputted to the gate of Tr5. One end of a drain-source line of Tr4 is connected to the cathode of the photodiode PD, and the other end thereof is connected to the gate of Tr2. The transfer pulse Trn can be inputted to the gate of Tr4. One end of a drain-source line of Tr1 is connected to the power source V_{DD}, and the other end thereof is connected to the gate of Tr2. The reset pulse Grst can be inputted to the gate of Tr1. One end of a drain-source line of Tr2 is connected to the power source V_{DD}, and the other end thereof is connected to one end of a drain-source line of the horizontal read line selecting Tr3. The other end of the drain-source line of Tr3 is connected to a vertical signal line (vertical read line) H₁, and the read line selecting pulse Lsl can be inputted to the gate of Tr3. The power source V_{DD} is a positive power source or a negative power source depending on whether the used transistors are of the N channel type or the P channel type.

The pixel P₃₁ controlled by the control unit 1A-2 has the same configuration as that of the pixel P₁₁.

The control units 1A-1, 1A-2 have accumulation time control units 1A-11, 1A-12, respectively, so that the accumulation time can be freely set per pixel by each vertical scan circuit for controlling the corresponding pixel.

For the sake of simplicity, the following description is made of, by way of example, a solid-state image-pickup sensor of the so-called global shutter type capable of performing accumulation control in units of frame at a time by each vertical scan circuit. The term “global shutter type” originally means an electronic shutter system capable of making simultaneous exposure of all the pixels at the same timing.

First, Tr1 is turned on by Grst to release the charges at the Tr2 gate for resetting thereof. In other words, Tr2 is reset such that the Tr2 gate is brought into a state ready for reading a signal from the photodiode PD. During the resetting, photo charges are accumulated in PD. Tr5 is the transistor for resetting (sweeping away) the PD charges. Upon Tr5 being turned on by Prst, the charges accumulated in the photodiode PD are cleared (i.e., the accumulated charges are escaped to a substrate). Accumulation of new photo charges is started immediately after the escape of the charges.

Then, upon Tr4 being turned on by Trn, the photo charges accumulated in PD for a predetermined period are transferred to the Tr2 gate. At this timing, the substantial accumulation of the PD charges is brought to an end. Thereafter, Tr2 performs voltage conversion. A thus-generated photoelectrically converted signal is sent to the vertical signal line H₁ upon Tr3 being turned on by Lsl, followed by transfer to the horizontal scan circuit.

In this third embodiment, the PD charge reset pulse Prst (i.e., the pulse for resetting the charges accumulated in PD) shown in FIG. 5 is independently controlled for each pixel within the pixel group, described in the second embodiment, by different one of the vertical scan circuits.

FIG. 6 shows a read sequence of the photoelectrically converted signals in the solid-state image-pickup sensor (see FIG. 3 for the sensor configuration) according to the third embodiment. It is here assumed that SS1-SS4 denote respective PD charge reset pulses Prst from the vertical scan circuits 1A-4A shown in FIG. 3, SE1-SE4 denote respective PD charge transfer pulses Trn, and AC1-AC4 denote respective accumulation times controlled by those pulses. When SSn (n=1-4) is turned to an H level, the PD charges are reset and the accumulation of new photo charges is started, and the accumulation of the charges is brought to an end by turning SEn (n=1-4) to an H level.

For example, by turning on SS1 to an H level and turning off it after a certain period, PD is reset and the accumulation of new photo charges is started. Then, by turning on Tr4 by SE1, the accumulated charges are transferred, thus resulting in shutter release. In response, the accumulation of the charges is actually brought to an end, and the charges to be read are decided. A period from a fall of SS1 to a fall of SE1 is the accumulation time.

For example, the vertical scan circuit 1A in FIG. 3 executes control to read the photoelectrically converted signals from the pixels P₁₁, P₁₃, P₃₁ and P₃₃ for an accumulation time V₁₋ₙ (n: integer≧1). While the read control is likewise executed in the other vertical scan circuits, the accumulation times V₁₋ₙ, V₂₋ₙ controlled respectively by the vertical scan circuits 1A, 2A are set to have a length different from that of the accumulation times V₃₋ₙ, V₄₋ₙ controlled respectively by the vertical scan circuits 3A, 4A, whereby four small frame images corresponding to two different lengths of the accumulation time are obtained as the outputs 1-4 at the same time.

With the above-described configuration and control, small frame images corresponding to different lengths of the accumulation time can be obtained at the same time by independently adjusting the accumulation time in units of adjacent pixels within an arbitrary pixel group.

### Fourth Embodiment

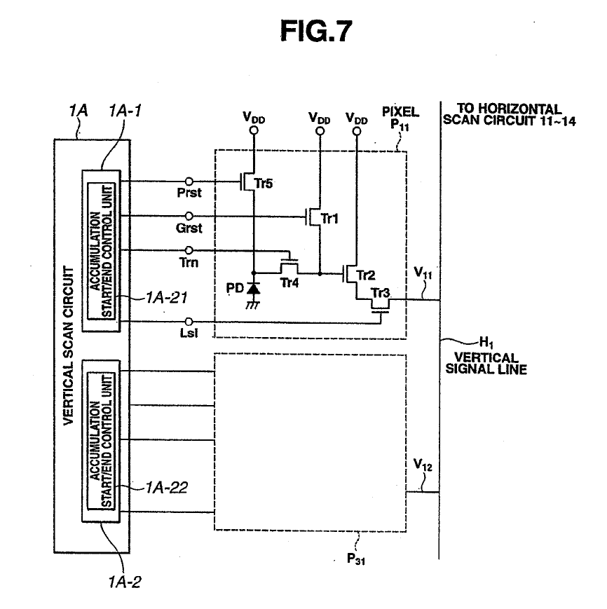

FIG. 7 is a configuration figure of pixels and a control unit for the pixels in a solid-state image-pickup sensor according to a fourth embodiment of the present invention. The block diagram of the solid-state image-pickup sensor according to the fourth embodiment of the present invention is the same as that shown in FIG. 3, and therefore it is omitted in FIG. 7. The configuration of FIG. 7 is basically similar to that of FIG. 5, but control units (e.g., 1A-1, 1A-2 in FIG. 7) in vertical scan circuits include respectively accumulation start/end control units 1A-21, 1A-22 so that the start and end of the accumulation time can be freely set per pixel by each vertical scan circuit for controlling the corresponding pixel.

For the sake of simplicity, the following description is made of, by way of example, a solid-state image-pickup sensor of the so-called global shutter type capable of performing accumulation control in units of frame at a time by each vertical scan circuit. The pixel configuration and control operation are the same as those in the third embodiment, and therefore a description thereof is omitted here.

In the fourth embodiment, the accumulation start timing decided by the PD charge reset pulse Prst (i.e., a shutter start pulse SSn (n=1-4)) shown in FIG. 7 and the accumulation end timing decided by the PD charge transfer pulse Trn (i.e., a shutter end pulse SEn (n=1-4)) are independently controlled for each pixel within the pixel group, described in the second embodiment, by different one of the vertical scan circuits.

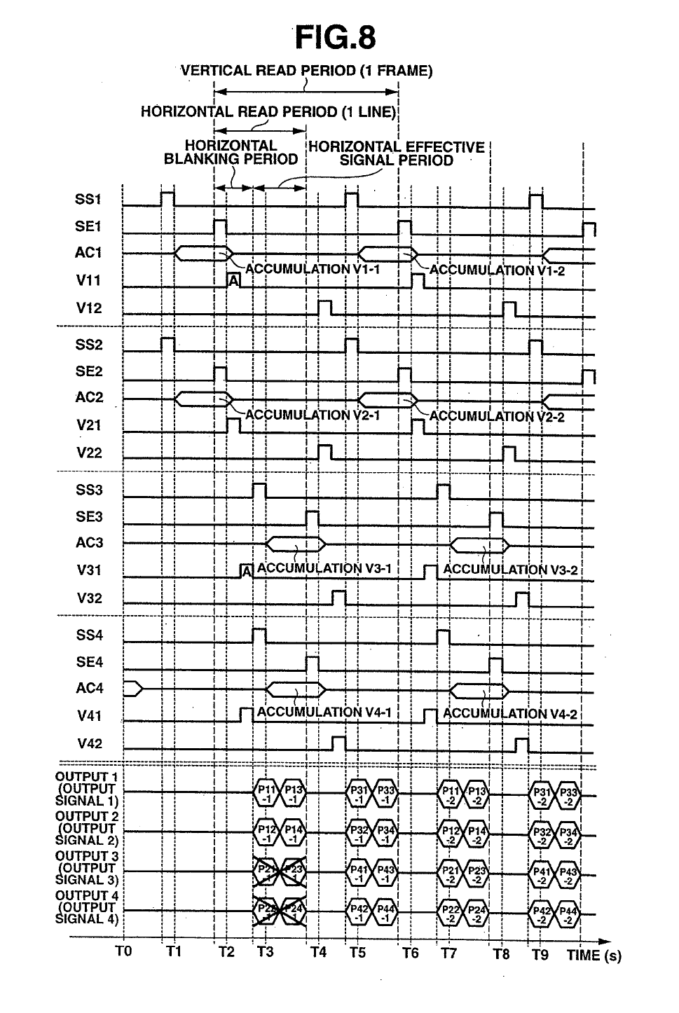

FIG. 8 shows a read sequence of the photoelectrically converted signals in the solid-state image-pickup sensor (see FIG. 3 for the sensor configuration) according to the fourth embodiment. In FIG. 8, the horizontal axis represents time. T₀(s) represents the scan start time, and Tₙ(s) represents a time lapsed from the scan start time. It is here assumed that SS1-SS4 denote respective PD charge reset pulses Prst from the vertical scan circuits 1A-4A shown in FIG. 3, SE1-SE4 denote respective PD charge transfer pulses Trn, and AC1-AC4 denote respective accumulation times controlled by those pulses. When SSn (n=1-4) is turned to an H level, the PD charges are reset and the accumulation of new photo charges is started, and the accumulation of the charges is brought to an end by turning SEn (n=1-4) to an H level. Stated another way, the accumulation start is controlled by the SSn pulse, and the accumulation end is controlled by the SEn pulse. The accumulation start/end control units 1A-21, 1A-22 in each vertical scan circuit can freely set both the pulses SSn, SEn independently of each other.

For example, the vertical scan circuit 1A in FIG. 3 executes control to read the photoelectrically converted signals from the pixels P₁₁, P₁₃, P₃₁ and P₃₃ for an accumulation time V₁₋ₙ (n: integer≧1) by starting the accumulation at time T₁(s) and ending the accumulation at time T₂(s) in FIG. 8. While the read control is likewise executed in the other vertical scan circuits, the accumulation times V₁₋ₙ, V₂₋ₙ controlled respectively by the vertical scan circuits 1A, 2A are set to have the accumulation start and end timings different from those of the accumulation times V₃₋ₙ, V₄₋ₙ controlled respectively by the vertical scan circuits 3A, 4A, whereby small frame images corresponding to the same accumulation time, but having two different sets of the accumulation start and end times (i.e., different accumulation start/end timings) are momentarily obtained as the outputs 1-4 at a time difference shifted from each other corresponding to the different accumulation end timings.

More specifically, the output 1 provides a small frame image 1 formed by the photoelectrically converted signals P₁₁₋₁, P₁₃₋₁, P₃₁₋₁ and P₃₃₋₁ from the pixels P₁₁, P₁₃, P₃₁ and P₃₃ accumulated from the accumulation start time T₁(s) and read at the accumulation end time T₂(s), and the output 2 provides a small frame image 2 formed by the photoelectrically converted signals P₁₂₋₁, P₁₄₋₁, P₃₂₋₁ and P₃₄₋₁ from the pixels P₁₂, P₁₄, P₃₂ and P₃₄ accumulated from the accumulation start time T₁(s) and read at the accumulation end time T₂(s). The output 3 provides a small frame image 3 formed by the photoelectrically converted signals P₂₁₋₁, P₂₃₋₁, P₄₁₋₁ and P₄₃₋₁ from the pixels P₂₁, P₂₃, P₄₁ and P₄₃ accumulated from the accumulation start time T₃(s) and read at the accumulation end time T₄(s), and the output 4 provides a small frame image 4 formed by the photoelectrically converted signals P₂₂₋₁, P₂₄₋₁, P₄₂₋₁ and P₄₄₋₁ from the pixels P₂₂, P₂₄, P₄₂ and P₄₄ accumulated from the accumulation start time T₃(s) and read at the accumulation end time T₄(s). Then, those small frame images are obtained at the respective timings shifted from each other corresponding to the difference (T₄−T₂)(s) between the two accumulation end timings.

A mark x in FIG. 8 will be described below. On the time base, T₀(s) denotes the scan start time. Looking at the outputs 3 and 4, the scan is started from T₀(s), but there are no signals SS3, SE3, SS4 and SE4 deciding the accumulation timing before the first read timing decided by the vertical selection pulses V₃₁, V₄₁ (i.e., during a period of (T₀-T₂)) because the accumulation timing is shifted between the scan lines. Accordingly, although the pixels P₂₁, P₂₂, P₂₃ and P₂₄ are also read at the first read timing decided by the vertical selection pulses V₃₁, V₄₁, those pixels contain no accumulated data and the exposed pixel signals are dropped out. For that reason, the mark x is indicated as shown.

Stated another way, the small frame images 1, 2 for which the accumulation start and end timings are set to earlier points in time can be outputted as complete small frame images from the beginning, while the small frame images 3, 4 for which the accumulation start and end timings are set to later points in time are outputted as incomplete small frame images in only one frame, i.e., the first frame, and then outputted as complete small frame images.

With the above-described configuration and control, small frame images corresponding to different shutter timings can be obtained with a minimum time difference by independently adjusting the accumulation start and end timings in units of adjacent pixels within an arbitrary pixel group.

An image-pickup device using the solid-state image-pickup sensor of the second embodiment, shown in FIG. 3, will be described below.

### Fifth Embodiment

FIGS. 9 and 10 shows a configuration of an image-pickup device according to a fifth embodiment of the present invention. Specifically, FIG. 9 is a basic block diagram, and FIG. 10 is a block diagram of the image-pickup device with an image-pickup condition setting function.

The image-pickup device shown in FIG. 9 comprises a condenser lens 21, a solid-state image-pickup sensor 22, which is constructed as shown in FIG. 3, for receiving a light having passed the condenser lens 21 and performing photoelectric conversion, a signal processing unit 23 for processing photoelectrically converted signals (with regards to y characteristic, gain adjustment, etc.) and sending the processed signals to a recording unit, a display unit, etc. (not shown) in succeeding stages, a clock generator 24 for generating a clock to manage the operation of the image-pickup device, and a read control unit 25 for receiving the clock and executing control of pixel read from the solid-state image-pickup sensor 22. The read control unit 25 controls the vertical scan circuits 1A-4A shown in FIG. 3.

The image-pickup device of FIG. 10 is configured to employ, among the outputs 1-4, the output 4 to detect image-pickup conditions (adjustment conditions such as the accumulation time and the accumulation start/end timing). More specifically, the signal from the output 4 is sent to an image-pickup control signal processing unit 26 after being processed by the signal processing unit 23, and a result obtained by automatically detecting optimum image-pickup conditions from that signal is sent to the read control unit 25. Then, the read control unit 25 sets the optimum image-pickup conditions and controls the pixel read from the solid-state image-pickup sensor 22 shown in FIG. 3.

When the image-pickup device having the above-described configuration is applied to a still-image camera, e.g., a digital still camera, it is required to quickly take one shot. Therefore, after quickly feeding back image-pickup information and setting the solid-state image-pickup sensor 22 to an optimum operating state, the read state of the output 4 is returned to a normal state and a shutter is actually released to take a shot. In other words, the image-pickup device is controlled such that the output 4 is initially used for the control, and when taking a full image, the output 4 is returned to the normal state to read all pixels.

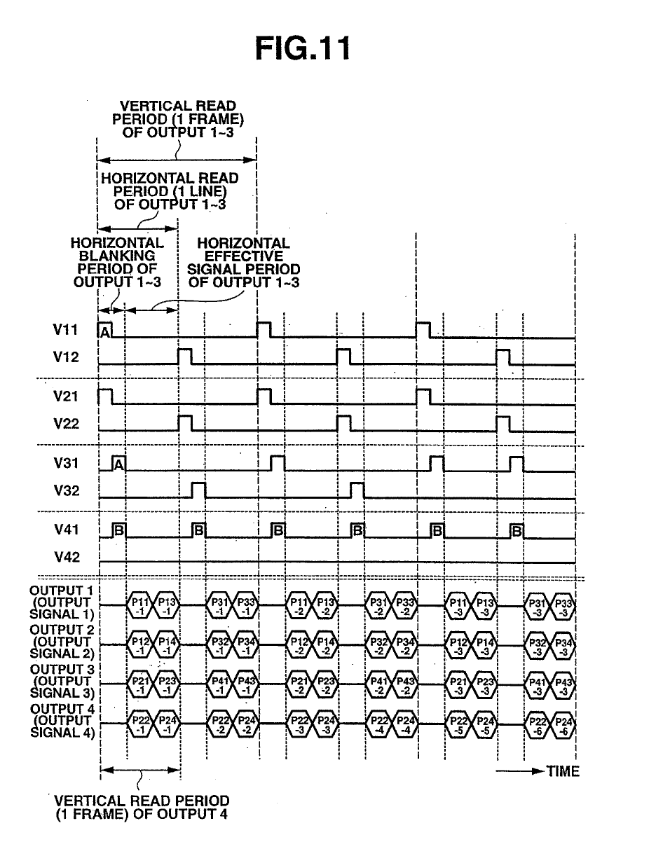

The operation of the image-pickup device shown in FIG. 10 will be described below with reference to FIG. 11.

FIG. 11 shows a sequence for controlling the solid-state image-pickup sensor by the read control unit 25 in FIG. 10. This control sequence represents the image-pickup condition setting operation that is executed, for example, with a shutter button depressed half prior to shutter release. The following description is made of, in particular, vertical selection pulses (equivalent to read control pulses) V₄₁, V₄₂ supplied from the vertical scan circuit 4A to obtain the output 4, as well as an output signal 4.

As indicated by B in FIG. 11, the vertical selection pulse V₄₁ from the vertical scan circuit 4A controls only the pixels P₂₂, P₂₄ in FIG. 3 to be set to an H level per horizontal blanking period (see the second embodiment) such that the photoelectrically converted signals from those pixels are read (whereas vertical selection pulses V₁₁, V₁₂, V₂₁, V₂₂, V₃₁ and V₃₂ are set to an H level per two horizontal blanking periods). On the other hand, a vertical selection pulse V₄₂ is always held at an L level to prevent the photoelectrically converted signals from being read from the corresponding connected pixels. As a result of that control, the output 4 provides a signal output (output signal 4) shown in FIG. 11. The vertical selection pulses supplied from the vertical scan circuits 1A-3A to respectively obtain the outputs 1-3 are the same as those in the second embodiment, and therefore a description thereof is omitted here.

With the operation, because pairs of the same pixel outputs P₂₂₋₁, P₂₄₋₁ are repeatedly outputted per horizontal blanking period and there are no outputs in response to the vertical selection pulse V₄₂, the number of pixels outputted as the output 4 and constituting a small frame image becomes ½ of the number of pixels of a small frame image obtained from each of the outputs 1-3 during the vertical read period, namely the number of lines is reduced to ½. As a result, the frame rate of the small frame image obtained from the output 4 is doubled as compared with that of the small frame image obtained from each of the other outputs 1-3.

Thus, the small frame images differing in number of image-constituting pixels can be read out at different frame rates depending on the outputs. Further, by executing processing of an image-pickup control signal using the small frame image signal obtained at a high speed from the output 4 and feeding back the processed signal for the read control, the image-pickup conditions, such as setting of the accumulation time and the accumulation start/end timing (see the third and fourth embodiments), can be set at a higher speed to be adapted for changes of a subject.

As described above, in the image-pickup condition setting operation, since particular pixels are read per horizontal blanking period by using the vertical selection pulse V₄₁, signal outputs from the same pixels can be repeatedly obtained at a shorter cycle (higher speed). Therefore, the image-pickup conditions can be quickly set and fed back so that the read conditions of the solid-state image-pickup sensor 22 can be quickly changed to optimum ones. On the other hand, since the vertical selection pulse V₄₂ is held at an L level, no pixel signals are read in response to V₄₂. However, that control operation is executed in a very short time, i.e., just during a period for the image-pickup condition setting operation. After the image-pickup condition has been set based on the output 4, the read of the output 4 is returned to the normal state (namely, the output 4 also provides signals of four pixels during two horizontal blanking periods similarly to the other outputs 1-3) as shown in the scan sequence of FIG. 4 described above in connection with the second embodiment, followed by actual shutter release.

By incorporating, in a solid-state image-pickup device, the solid-state image-pickup sensor 22 shown in FIG. 3 and the read control unit 25 for executing the read control, the solid-state image-pickup device is able to develop the functions given below.

With the application of the third embodiment, for example, since the spatial phase difference between the small frame images corresponds to one pixel, one frame having a wide dynamic range and providing a less awkward feeling can be obtained by synthesizing the small frame images corresponding to the different accumulation times from each other. It is also possible to obtain small frame images corresponding to a plurality of accumulation times during one shutter operation and to select one with an optimum exposure from among the small frame images as a final effective frame.

Further, with the application of the fourth embodiment to a still-image camera, since images corresponding to a plurality of different shutter timings can be obtained during one shutter operation, it is possible to obtain an image at the optimum timing, e.g., a small frame image resulting from excluding the frame taken at the moment at which a person as a subject blinks.

In order to obtain, e.g., an AF (Auto-Focusing) control signal for setting of the image-pickup conditions, the image-pickup control signal processing unit 26 extracts a high-frequency component from the image-pickup signal obtained as the output 4, and supplies a signal corresponding to the extracted high-frequency component, as the AF control signal, to the read control unit 25. In the case of AF adjustment, however, the read control unit 25 is required to execute control to move the position of the condenser lens 21 in the direction of an optical axis (back and forth) and to stop the lens 21 at a position (focused position) where a maximum amplitude of the AF control signal is acquired.

According to the present invention, since selection of the pixels to be read, the accumulation time, and the accumulation start/end timing can be alterably set per pixel, a wide variety of image-pickup conditions can be set and versatile application methods can be developed with regards to processing and creation of captured images. As a result, a highly versatile solid-state image-pickup sensor and device can be realized.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A solid-state image-pickup sensor comprising:
a plurality of vertical scan circuits;
a plurality of horizontal scan circuits;
a pixel section including pixels arranged in a two-dimensional array, each pixel being configured to perform photoelectric conversion, each pixel being connected to only one of the plurality of vertical scan circuits and being connected to the plurality of horizontal scan circuits; and
a selection unit for controlling each of the horizontal scan circuits to independently select and output photoelectrically converted signals read from the plurality of pixels arrayed in a horizontal direction,
wherein given ones of the pixels arranged in the two-dimensional array are selected in at least one of the vertical direction and the horizontal direction to form a pixel group, the selected pixels within the pixel group being connected to different vertical scan circuits, and the photoelectrically converted signal from each of the pixels within the pixel group being outputted from different horizontal scan circuits.

2. The solid-state image-pickup sensor according to claim 1, wherein the plurality of vertical scan circuits include a unit configured to independently control an accumulation time in each of the pixels within the pixel group connected to the plurality of vertical scan circuits.

3. The solid-state image-pickup sensor according to claim 1, wherein the plurality of vertical scan circuits include a unit configured to independently control accumulation start timing and accumulation end timing in each of the pixels within the pixel group connected to the plurality of vertical scan circuits.
